(19) United States
(12) Patent Application Publication
(10) Pub. No.: US 2016/0288472 A1
(43) Pub. Date: Oct. 6, 2016

(54) PASTE SUPPORT

(71) Applicants: MYUNG-SOO KIM, INCHON-CITY (KR); HOJIN AN, KOYANG-CITY (KR)

(72) Inventors: MYUNG-SOO KIM, INCHON-CITY (KR); HOJIN AN, KOYANG-CITY (KR)

(21) Appl. No.: 15/083,929

(22) Filed: Mar. 29, 2016

(30) Foreign Application Priority Data
Mar. 30, 2015 (KR) 10 2015-0044155

(51) Int. Cl. B32B 37/00

(52) U.S. Cl. CPC B32B 37/0046

(57) ABSTRACT

A number of protrusions for pasting are provided at the bottom surface of a base plate with a predetermined interval (d) between each of the protrusions, and each of the protrusions are provided with a distal end portion having a rounded tip so that the area contacting with a subject to be pasted (T) and the distal end portion of the protrusions for pasting can be minimized, and contamination of subsequent subjects to be pasted by residual paste can be avoided during a pasting operation of envelopes or other papers.

### CROSS REFERENCE TO RELATED APPLICATIONS

This application claims priority to Korean application KR 10-2015-0044155 filed Mar. 30, 2015, the contents of such application being incorporated by reference herein.

### FIELD OF THE INVENTION

This invention relates to a paste support, having the structure for minimizing the contacting area between a paper and a support (underlay) to avoid the reverse side of the paper being contaminated or stuck to the support due to residual paste left on the support, when paste is applied to an envelope or a paper, thereby solving the problem during pasting operation. Further, this paste support has the structure for extending the support by attaching extension support(s) for pasting larger paper easily.

### BACKGROUND OF THE INVENTION

Generally, paste is used for sticking paper or the like in offices or schools in daily life, or for sticking receipts or photographs in offices and at homes.

For example, in order to stick a receipt onto a paper with said receipt being fully applied with paste to the end of the receipt, the pasting operator in an office will use a separate paper as a support (underlay) so as to avoid the paste to go outside the supporting paper, or will firstly apply paste in the center portion of the receipt paper and then extend the paste toward the end, holding the end of the receipt paper by his/her hand.

On the other hand, it is difficult to apply paste without the paste going out from the end of a paper to be pasted, or even though the paste is successfully applied, residual paste may be stuck to the support or the operator's finger.

### DESCRIPTION OF THE RELATED ART

To solve the above mentioned problems, a prior art “Paste Guiding Device” (Korean Patent Registration Number 10-1503483, registered on Mar. 3, 2015) was invented.

The prior art has paste guides (110) which are connectable to each other and a paste holder (140) for attaching the paste.

Paste can be applied to the end of a paper using the paste held by a paste holder (140), in a manner that the paste guide (110) is moved along the end of a subject to be pasted. The paste holder is connected to the paste guide (110) in a manner that the outer surface of the paste is elastically supported. The paste guide (110) has a pair of elastic members which is elastically deformable by applying external force, has a shape of brackets with a part opened, and also has a friction portion to enhance the friction between the paste and the paste holder (140).

However, this prior art had a problem. If the paste is applied to a paper end several times, peripheral portion of the paste guide (110) will be contaminated by the paste thereby contaminating the next paper to be pasted.

Furthermore, this prior art did not provide a means for solving the problem of the residual paste on the support (underlay), as such cleaning papers had been used for cleaning the residual paste to avoid the support to be contaminated, meaning that cleaning papers as well as time had been wasted.

### SUMMARY OF THE INVENTION

### Problems to be Solved

This invention was invented to solve the problems of the prior arts. The purpose of this invention is to avoid papers to be subsequently pasted being contaminated by the residual paste, by providing protrusions for pasting, said protrusions for pasting being for minimizing the amount of paste to be applied to the paste support outside the paper to be pasted when paste is applied to the end of the paper, enabling subsequent large amount of pasting operation being done easily.

### Means for Solving the Problems

To attain the above mentioned purpose, this paste support comprises a base plate and a number of protrusions protruding for pasting upwardly from the upper surface of said base plate, each of said protrusions for pasting being positioned with a predetermined interval.

The upper portion of said distal end portion of protrusions for pasting have rounded distal ends for pasting, so that the contacting area with the subject to be pasted should be minimum.

Each protrusion for pasting has a diameter of 0.2 mm to up to 3.0 mm, and the height is 3 mm to up to 10 mm.

The interval from a protrusion to other protrusions for pasting is 1 mm to up to 6 mm.

At both lateral sides of a base plate, lower ends for extension extending outwardly from the bottom side of the base plate and upper ends for extension extending outwardly from the top side of the base plate are provided for extending the paste support by stackedly fitting said upper end for extension of a base plate and a lower end for extension of another base plate to each other. The lower end for extension is provided with a number of columns for extension protruding vertically, and the upper end for extension is provided with a number of column fitting holes to be fitted with the columns for extension.

### Effect of the Invention

The paste support of this invention has the effects as explained below.

The first effect is that the upper distal ends of the columns of the paste support are R-shaped or have hemispherical tip so that the area contacting with a subject to be pasted should be minimized. In this way, pasting operation will not be obstructed by contamination by the sticking residual paste.

The second effect is that a large sized envelope or the like can be easily pasted by extending the area of pasting operation, by stackedly fitting said base plates having the lower end for extension at their lateral sides provided with the columns for extension. In this way, large operation area is ensured during the pasting operation of a number of envelopes or papers.

The third effect is that pasting operation can be done steadily and productively since a planar operation supporting plate is provided at one side of the base plate for supporting the hand or wrist of an operator securing the subject to be pasted.

### BRIEF DESCRIPTION OF THE DRAWINGS

The invention is best understood from the following detailed description when read in connection with the accompanying drawings. Included in the drawings are the following figures:

FIG. 1 is the perspective view of the paste guiding device of the prior art.

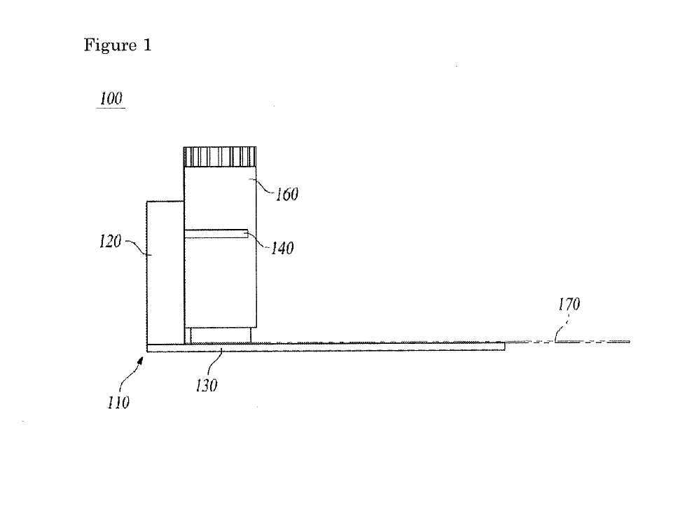

FIG. 2 is the perspective view of the paste support of this invention.

FIG. 3 shows the plan view and the front view of the paste support of this invention.

FIG. 4 is the side view showing the extension of the support (underlay) of the paste support of this invention.

FIG. 5 is the perspective view of another embodiment of the paste support of this invention.

### DETAILED DESCRIPTION OF THE PREFERRED EMBODIMENTS

The followings are explanations of the paste support of this invention, referring to the annexed figures.

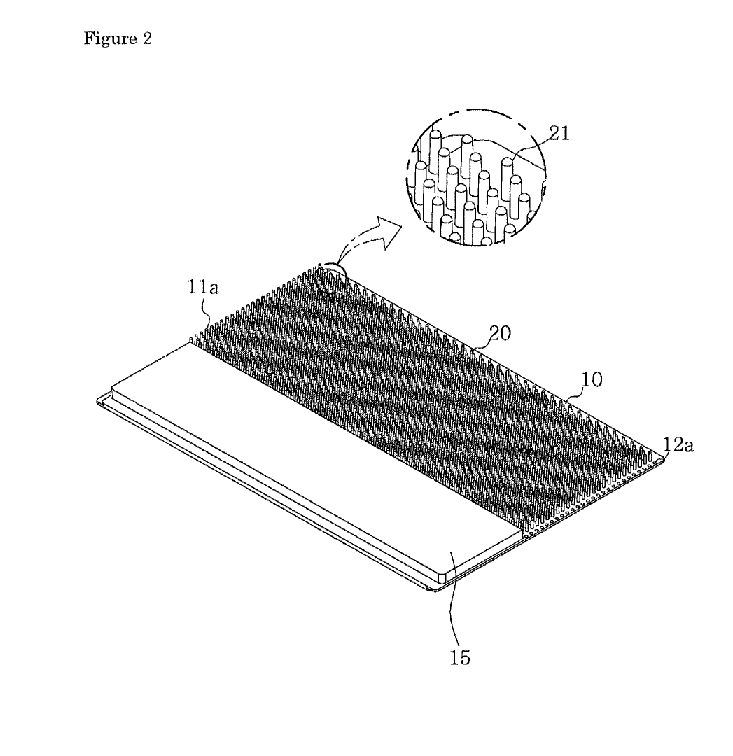

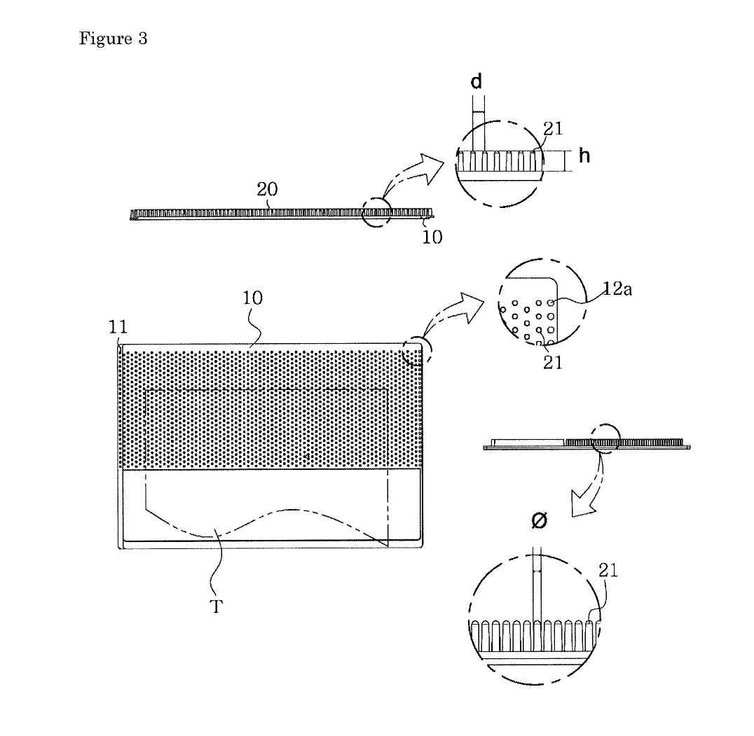

As shown in FIGS. 2 and 3, the upper portion of a number of distal ends of the protrusions for pasting having predetermined interval (d) one another, which vertically protrude at the top surface of a base plate (10), have the distal end portion of protrusion for pasting (21) having rounded tips so that the contacting area with the subject to be pasted can be minimized.

Basically, each tip of said distal end portion of protrusion for pasting (21) preferably has hemispherical shape, each said protrusion having shape of a stick or rectangular column, so that the subject to be pasted (T) can be contacted at points rather than a plane.

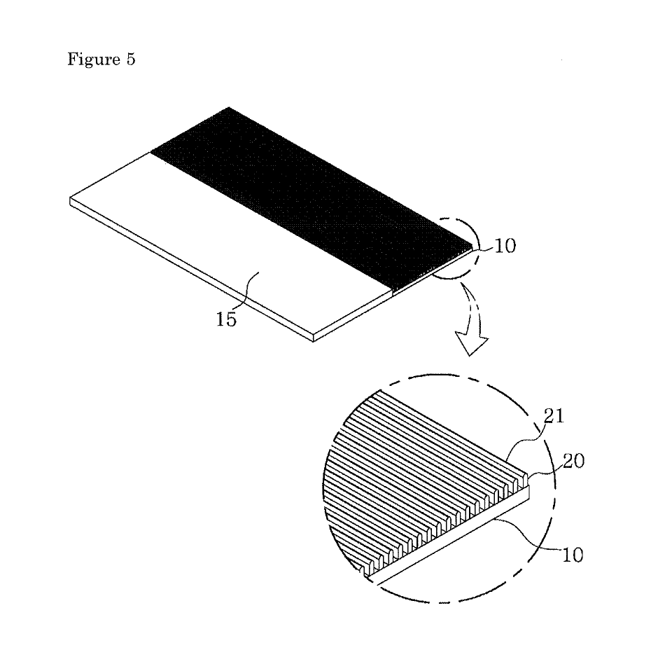

Another embodiment is shown in FIG. 5, in which the distal end portion of protrusions for pasting (21) has rectangular protrusions for pasting (20). In this embodiment, residual paste at the ends of said protrusions for pasting (20) will fall down along the side of said protrusions for pasting (20).

Each protrusion for pasting (20) has a diameter of 0.2 mm to up to 3.0 mm, and a height of 3 mm to up to 10 mm.

The aggregation of said protrusions for pasting (20) having the diameter (0) and the height (h) enables large amount of pasting operation, and avoids the subject to be pasted (T) to be contaminated by the residual paste after pasting operation. In this way, the pasting operation can be done easily.

Moreover, said interval (d) among the protrusions for pasting is set to 1 mm to up to 6 mm, enabling easier pasting operation.

At both lateral sides of the base plate (10), the lower end for extension (11) extended outwardly from the bottom side of the base plate (10) and the upper end for extension (12) extended outwardly from the top side of the base plate (10) are provided for extending the paste support by stackedly fitting the upper end for extension (12) of the base plate (10) and the lower end for extension (11) of another base plate (10) to each other. The lower end for extension (11) is provided with a number of columns for extension (11a) protruding vertically, and the upper end for extension (12) is provided with a number of column fitting holes (12a) to be fitted with the columns for extension (11a). The paste support of this invention can be extended wider by stackedly connecting additional supports, as such, not only normal sized envelopes but larger sized envelopes can also be easily pasted.

A planar operation supporting plate (15) is provided at one side of the base plate (10) for supporting the subject to be pasted (T) during the pasting operation.

Area of the distal end portion of protrusions for pasting (21) are set to be 0.01% to up to 25% of the base plate (10) in terms of area ratio. For example, the distal end portion of protrusions for pasting (21) is set to be 0.0001 cm² to up to 0.25 cm per 1 cm of the base plate (10).

Here, the mechanism of this invention is explained.

In the paste support of this invention, as shown in FIGS. 2 and 3, a number of protrusions for pasting (20) support the subject to be pasted (T), and said protrusions for pasting (20) have the distal end portion of protrusions for pasting (21) with their upper distal ends of the protrusions for pasting for contacting with the subject to be pasted (T) so that the residual paste to be left after pasting operation should be minimized.

The protrusions for pasting (20) is provided with the base plate (10) at their bottom surface, and the protrusions for pasting (20) are positioned with predetermined interval (d) on said base plate (10) so that the subject to be pasted (T) e.g. a paper will not be unsteadily moved in between the protrusions for pasting (20) by pushing force. The interval (d) of 1 mm to up to 6 mm is the optimum with which paste can be fully applied and at the minimum amount of paste to the subject to be pasted (T).

Moreover, the diameter (0) of each of the protrusions for pasting (20) is set to 0.2 mm to up to 3.0 mm and the height (h) is set to 3 mm to up to 10 mm, to avoid the protrusions for pasting (20) to be excessively deflected when the subject to be pasted (T) is put on the surface of said protrusions for pasting (20), thereby enabling smooth pasting operation.

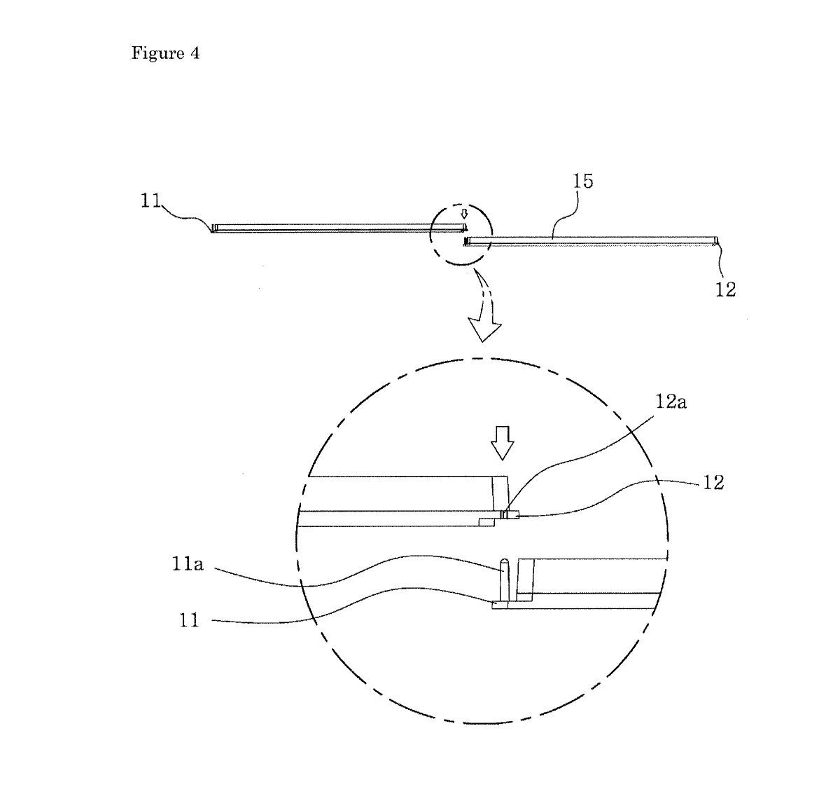

As shown in FIG. 4, the base plate (10) has the upper end for extension (11) and the lower end for extension (12) at its both lateral sides so that the paste support can be extended by conjoining two base plates (10). As such, the subject to be pasted (T) having large area such as a large sized envelope or the like can be easily pasted by extending said base plate (10).

The lower end for extension (11) is provided with columns for extension (11a) and the upper end for extension (12) is provided with column fitting holes (12a). The columns for extension (11a) and the column fitting holes (12a) are stackedly fitted to each other to extend the base plate (10).

The planar operation supporting plate (15) is extendedly provided at one side of the base plate (10) for supporting the operator's hand or wrist so that the pasting operation can be done easily.

### INDUSTRIAL APPLICABILITY OF THIS INVENTION

This invention shall not be limited to the above mentioned specific embodiments, but various alterations are possible within the scope of the claims by any person who has general knowledge in the arts of this invention, and such alterations are included within the scope of the claims.

1-6. (canceled)

7. A paste support comprising:
a base plate having a surface; and
a plurality of protrusions for pasting having an interval (d) and extending upwardly from the surface of the base plate, a distal end portion at an upper end of each protrusion for pasting having a rounded shape such that a contacting area with a subject to be pasted (T) is minimized during a pasting operation.

8. The paste support of claim 7, wherein each of the plurality of protrusions for pasting has a diameter (ø) between of 0.2 mm and 3.0 mm and a height (h) between 3 mm and to 10 mm.

9. The paste support of claim 7, wherein said interval (d) is between 1 mm and 6 mm.

10. The paste support of claim 7, wherein said base plate includes a lower end for extension extending outwardly and an upper end for extension extending outwardly such that said base plate can be stackedly extended, said lower end for extension having a plurality of vertical columns for extension and said upper end for extension having a plurality of column fitting holes.

11. The paste support of claim 10, further comprising:
a planar operation supporting plate positioned at a first side of said base plate such that the subject to be pasted (T) can be supported during the pasting operation.

12. The paste support of claim 7, further comprising:
a planar operation supporting plate positioned at a first side of said base plate such that the subject to be pasted (T) can be supported during the pasting operation.

13. The paste support of claim 7, wherein the area of the distal end portions of the plurality of protrusions for pasting is between 0.01% and 25% of the area of the surface of said base plate.
